(19) United States
(12) Patent Application Publication
(10) Pub. No.: US 2021/0168836 A1
(43) Pub. Date: Jun. 3, 2021

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN)

(73) Assignee: NTT DOCOMO, INC., Tokyo (JP)

(21) Appl. No.: 16/610,416

(22) PCT Filed: May 2, 2017
(86) PCT No.: PCT/JP2017/017299

§ 371 Date: Nov. 1, 2019

(51) Int. Cl. H04W 72/12; H04W 72/04; H04L 5/00; H04L 1/18

(52) U.S. Cl. CPC H04W 72/1263; H04W 72/042; H04L 1/1819; H04L 1/1835; H04W 72/0446; H04L 5/0055

(57) ABSTRACT

In order to control retransmission properly in a communication system that allows applying preemption to scheduling and/or controlling retransmission in smaller units than TBs, a user terminal, according to one aspect of the present invention, has a receiving section that receives a transport block (TB) comprising one or more code block groups (CBGs), a transmission section that transmits a delivery acknowledgment signal in response to the TB and/or the CBGs, and a control section that controls a receiving process and/or a transmission process for the delivery acknowledgment signal based on whether or not communication control based on the CBGs is reported and whether or not communication control based on preemption indication for the TB and/or the CBGs is reported.

### TECHNICAL FIELD

The present invention relates to a user terminal and a radio communication method in next-generation mobile communication systems.

### BACKGROUND ART

In the Universal Mobile Telecommunications System (UMTS) network, the specifications of long-term evolution (LTE) have been drafted for the purpose of further increasing high speed data rates, providing lower latency and so on (see non-patent literature 1). Also, the specifications of LTE-A (also referred to as “LTE-Advanced,” “LTE Rel. 10 to 13,” etc.) have been drafted for further broadbandization and increased speed beyond LTE (also referred to as “LTE Rel. 8 or 9”), and successor systems of LTE (also referred to as, for example, “Future Radio Access (FRA),” “5th Generation mobile communication system (5G),” “NR (New RAT (Radio Access Technology),” “LTE Rel. 14 and later versions,” etc.) are under study.

In existing LTE systems (for example, Rel. 13 and earlier versions), adaptive modulation coding (AMC), which adaptively changes at least one of the modulation schemes, the transport block size (TBS) and the coding rate, is executed for link adaptation. Here, the TBS is the size of transport blocks (TBs), which are units of information bit sequences. One or more TBs are assigned to 1 subframe.

Also, in existing LTE systems, when TBS exceeds a predetermined threshold (for example, 6144 bits), a TB is divided into one or more segments (code blocks (CBs)), and coding is done on a per segment basis (code block segmentation) Each encoded code block is concatenated and transmitted.

Also, in existing LTE systems, retransmission (Hybrid Automatic Repeat reQuest (HARQ)) of DL signals and/or UL signals is controlled in TB units. To be more specific, in existing LTE systems, even when a TB is segmented into a plurality of CBs, retransmission control information (“ACKnowledgment (ACK)” or “Negative ACK (HACK)” (hereinafter abbreviated as “A/N” and also referred to as “HARQ-ACK” and the like)) is transmitted in TB units.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (for example, 5G, NR, etc.), for example, it is predictable that larger TBS will be used in order to support communication of higher speed and larger capacity (eMBB (enhanced Mobile Broad Band)) than in existing LTE systems. TBs of such large TBS are likely to be segmented into many CBs compared to existing LTE systems (for example, 1 TB may be segmented into tens of CBs).

In this way, in future radio communication systems where the number of CBs per TB is anticipated to increase, when retransmission is controlled on a per TB basis as in existing LTE systems, even CBs in which no error is detected (which are therefore successfully decoded) have to be retransmitted, and this may cause a decline in performance/throughput. Therefore, in future radio communication systems, it is desirable to control retransmission in smaller units than TBs (for example, per group (code block group (CBG)) comprised of one or more CBs).

Meanwhile, future radio communication systems are under study to support Ultra Reliable and Low Latency Communications (URLLC), which requires better latency reduction and/or higher ability than eMBB. In this way, in future radio communication systems, a number of services with different requirements for latency reduction and/or reliability are likely to be co-present, so that research is underway to support multiple TTIs of different time lengths (including, for example, TTIs having a relatively long time length (hereinafter referred to as, for example, “long TTIs,” “TTIs for eMBB,” “first TTIs,” etc.) and TTIs having a relatively short time length (hereinafter referred to as, for example, “short TTIs,” “TTIs for URLLC,” “second TTIs,” etc.)).

In the event long TTIs and short TTIs are supported, it might occur that a short TTI is scheduled after a long TTI starts being transmitted (that is, a long TTI is pre-empted by a short TTI), in order to meet the requirements for latency reduction and/or reliability. “Preemption” means interrupting a long TTI's transmission by inserting a short and may be referred to as “interrupting a long TTI,” “hollowing out a long TTI,” or “puncturing a long TTI.” Alternatively, preemption can be paraphrased as, for example, interruption with a short TTI.

When preemption is supported, a short TTI may be scheduled in the data part inside a long TTI (for example, the punctured part in a long TTI) and the data part is retransmitted. In this case, the problem is how to control the retransmission. In particular, which retransmission control method is suitable for use might vary depending on whether or not retransmission control is implemented in smaller units than TBs (for example, in CBG units).

The present invention has been made in view of the above, and it is therefore an object of the present invention to provide a user terminal and a radio communication method, whereby retransmission can be controlled properly in a communication system that allows applying preemption to scheduling and/or controlling retransmission in smaller units than TBs.

### Solution to Problem

According to one aspect of the present invention, a user terminal has a receiving section that receives a transport block (TB) comprising one or more code block groups (CBGs), a transmission section that transmits a delivery acknowledgment signal in response to the TB and/or the CBGs, and a control section that controls a receiving process and/or a transmission process for the delivery acknowledgment signal based on whether or not communication control based on the CBGs is reported and whether or not communication control based on preemption indication for the TB and/or the CBGs is reported.

### Advantageous Effects of Invention

According to the present invention, retransmission can be controlled properly in a communication system that allows applying preemption to scheduling and/or controlling retransmission in smaller units than TBs.

### BRIEF DESCRIPTION OF DRAWINGS

FIG. 1 is a diagram to show an example of retransmission in CBG units;

FIGS. 2A and 2B are diagrams to explain UE buffer storage methods when preemption is applied;

FIG. 3 is a diagram to show an example of CBG-based transmission/retransmission according to a second example of the present invention;

FIGS. 4A and 4B are diagrams to show other examples of CBG-based transmission/retransmission according to the second example;

FIGS. 5A and 5B are diagrams to show other examples of CBG-based transmission/retransmission according to the second example;

FIG. 6 is a diagram to show another example of CBG-based transmission/retransmission according to the second example;

FIG. 7 is a diagram to show another example of CBG-based transmission/retransmission according to the second example;

FIG. 8 is a diagram to show another example of CBG-based transmission/retransmission according to the second example;

FIG. 9 is a diagram to show an example of a receiving process based on preemption indication information according to a third example of the present invention;

FIG. 10 is a diagram to show an example of a receiving process based on preemption indication information according to the third example;

FIG. 11 is a diagram to show an example of CBG-based transmission/retransmission and receiving process based on preemption indication information according to a fourth example of the present invention;

FIG. 12 is a diagram to show another example of CBG-based transmission/retransmission and receiving process based on preemption indication information according to the fourth example;

FIG. 13 is a diagram to show another example of CBG-based transmission/retransmission and a receiving process based on preemption indication information according to the fourth example;

FIG. 14 is a diagram to show another example of CBG-based transmission/retransmission and a receiving process based on preemption indication information according to the fourth example;

FIG. 15 is a diagram to show an exemplary schematic structure of a radio communication system according to the present embodiment;

FIG. 16 is a diagram to show an exemplary overall structure of a radio base station according to the present embodiment;

FIG. 17 is a diagram to show an exemplary functional structure of a radio base station according to the present embodiment;

FIG. 18 is a diagram to show an exemplary overall structure of a user terminal according to the present embodiment;

FIG. 19 is a diagram to show an exemplary functional structure of a user terminal according to the present embodiment; and

FIG. 20 is a diagram to show an exemplary hardware structure of a radio base station and a user terminal according to the present embodiment.

### DESCRIPTION OF EMBODIMENTS

Future radio communication systems (for example, 5G, NR, etc.) are anticipated to support services that require high speed and large capacity (for example, eMBB) and services that require ultra-high reliability and low latency (for example, URLLC).

For services like URLLC that require ultra-high reliability and low latency, short TTIs, which are TTIs having a relatively short time length, are suitable. This is so because short TTIs support high reliability (that is, retransmission in a short time) by providing short end-to-end latency (for example, frame fragmentation latency, transmission (Tx) latency and so on) and/or short round-trip time.

On the other hand, for services like eMBB that require high-speeds and large capacity, long TTIs, which are TTIs having a relatively long time length, are suitable. This is so because there is little control signal-induced overhead in long TTIs.

Therefore, studies are in progress, for future radio communication systems, to support long TTIs and short TTIs of varying time lengths at the same time (in the same carrier (cell, component carrier (CC), etc.). A long TTI may be constituted, for example, by 14 symbols, at a subcarrier spacing of 15 kHz, using a normal cyclic prefix (NCP). A long TTI may be referred to as a “normal TTI,” a “subframe,” and so on.

Also, a short TTI may be formed with a smaller number of symbols than a long TTI, at the same subcarrier spacing as a long TTI (for example, constituted by 1 or 2 symbols, ata subcarrier spacing of 15 kHz, using NCP). Alternatively, a short TTI may be formed with the same or a different number of symbols as a long TTI, at a higher (wider) subcarrier interval than a long TTI (for example, constituted by 14 symbols, at a subcarrier interval of 60 kHz, using NCP). Alternatively, a short TTI may be realized by combining both of these.

Now, in existing LTE systems (for example, LTE Rel. 13 and earlier versions), code block segmentation is employed, whereby a transport block (TB) that serves as a DL data scheduling unit is divided into one or more code blocks (CB), and each CB is encoded independently. The encoded bits of each CB are concatenated, modulated, mapped to available radio resources (for example, resource elements (REs)) first in the frequency direction, and then in the time direction (frequency-first time-second). The maximum number of encoded bits per CB is limited (for example, 6144 bits).

In existing LTE systems, retransmission is controlled on per a TB basis, irrespective of whether or not a TB is divided into a number of CBs. To be more specific, HARQ processes are assigned on a per TB basis. Here, HARQ processes are processing units in retransmission control, and every HARQ process is identified by an HARQ process number (HPN). One or more HARQ processes are configured in a user terminal (User Equipment (UE)), and, when HARQ processes bear the same HPN, the same data keeps being retransmitted until an ACK is received.

Also, in downlink control information (DCI) (DL assignment) that allocates the DL signal (for example, a PDSCH) for transmitting TBs, the radio base station can include the above HPN, a new data indicator (NDI) and a redundancy version (RV).

Here, the NDI is an indicator to distinguish between initial transmission and retransmission. For example, the NDI indicates retransmission if the HPN stays the same and the NDI is not toggled (bears the same value as the previous value), and indicates initial transmission if the NDI is toggled (has a different value from the previous value). In addition, the RV indicates the difference in the redundancy of transmission data. The values of RVs include, for example, 0, 1, 2 and 3, where 0 indicates the lowest degree of redundancy, and is used for initial transmission. By applying a different RV value to every transmission with the same HPN, HARQ gain can be achieved effectively.

As described above, in existing LTE systems, retransmission is controlled on a per TB basis, regardless of whether or not code block segmentation is employed. Consequently, when code block segmentation is employed, even if errors concentrate in part of C (C>1) CBs that are formed by dividing a TB, the whole TB is retransmitted. Therefore, not only CBs in which errors are detected (and which therefore fail to be decoded), but also CBs in which errors are not detected (successfully decoded) have to be retransmitted, which might cause a decline in performance (throughput). Future radio communication systems (for example, 5G, NR, etc.) are likely to have increased cases in which a TB is split into many CBs (for example, dozens of CBs), and therefore retransmission is likely to be controlled in smaller units than TBs (for example, per CBG, which is comprised of one or more CBs).

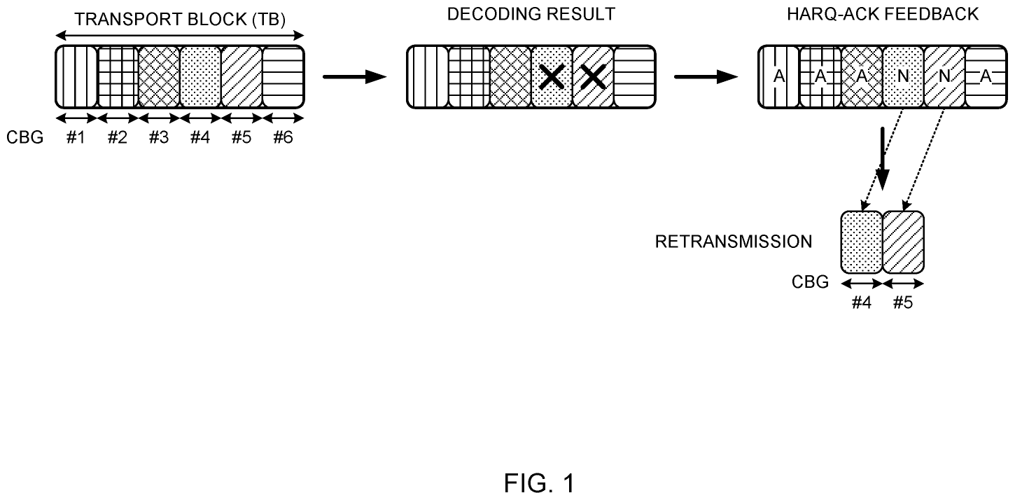

FIG. 1 shows an example of controlling transmission or retransmission of a signal in smaller units than TBs (for example, in CBG units (CBG-based)). In the case shown here, when 1 TB includes 6 CBGs (CBG #1 to #6), retransmission (including, for example, retransmission scheduling) is controlled and delivery acknowledgment signals (also referred to as “retransmission control signals,” “HARQ-ACKs,” “A/Ns,” etc.) are transmitted as feedback, on a per CBG basis. Note that TBs may include at least 1 CBG, and a CBG may be configured to include at least 1 CB.

For example, assume the case in which a user terminal decodes a TB that has been received, and, in doing so, fails to decode part of the CBGs. FIG. 1 shows a case in which CBGs #4 and #5 among the CBGs included in a received TB fail to be decoded (failed detection). In this case, the user terminal selects A/Ns per CBG, and transmits HARQ-ACKs as feedback. In FIG, 1, in response to CBGs #1 to #6, {A, A, A, N, N, A} are transmitted as feedback. A radio base station can control retransmission in CBG units, based on A/Ns transmitted from the user terminal as feedback. FIG. 1 shows a case in which CBGs #4 and #5 are retransmitted on a selective basis.

In this way, by controlling HARQ-ACK feedback and retransmission on a per CBG basis, the increase in overhead due to retransmission control can be reduced, and throughput can be improved.

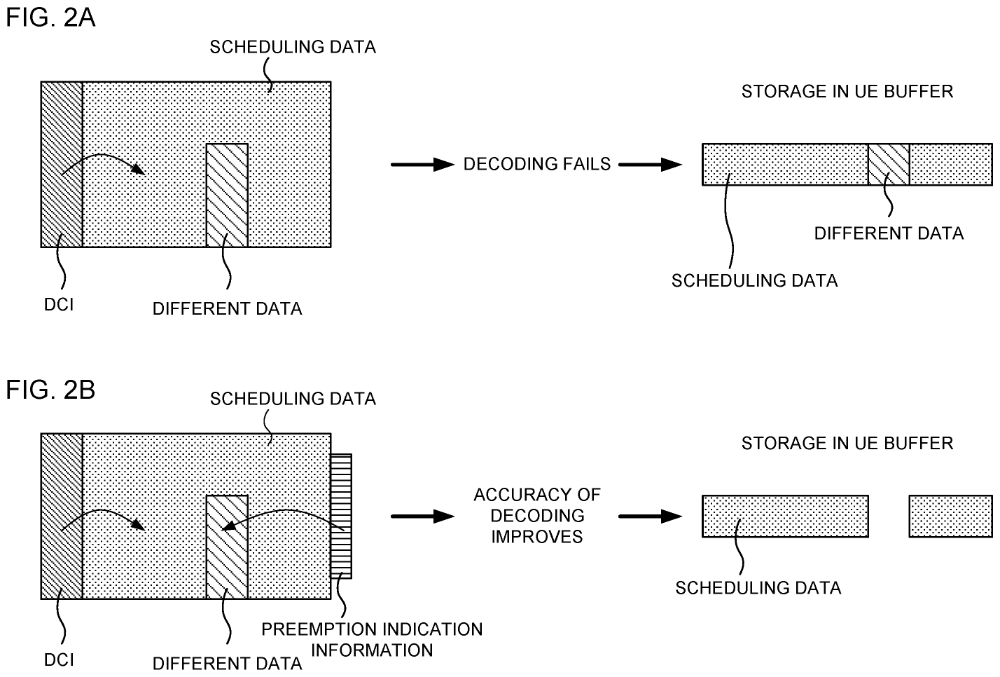

Meanwhile, as mentioned earlier, studies are in progress to support long TTIs and short TTIs in order to fulfill the requirements for different services (for example, eMBB, URLLC, etc.) in future radio communication systems. In the event long TTIs and short TTIs are supported, it might occur that a short TTI is scheduled after a long TTI starts being transmitted, in order to meet the requirements for latency reduction and/or reliability. To be more specific, it might occur that part of the DL data in a long TTI is preempted (“hollowed out,” “punctured,” etc.) a part of long TTI DL data and a short TTI DL data is inserted. If part of a long TTI is preempted by a short TTI, the radio base station can transmit the long TTI by puncturing the part of the long TTI data where the short TTI is scheduled. Therefore, a problem arises that a user terminal to receive this long TTI data cannot perform receiving processes (for example, demodulation and/or decoding) properly for this long TTI data (see FIG. 2A).

In this case, the user terminal judges that the detection of this long TTI data has failed (decoding failure), but still has no way of knowing that the data has been punctured by a short TTI. Therefore, the user terminal judges that the data scheduled by the short TTI (the interrupting short TTI data) is also addressed to the user terminal, and stores the data in the UE buffer (soft buffer). If data that is not addressed to the user terminal is stored in the UE buffer, the performance of the decoding process might drop and/or decoding might even fail when the long TTI data that is received in by way of retransmission and the data stored in the soft buffer are combined and decoded.

Therefore, research is underway to make a radio base station transmit indication information related to preemption of a long TTI by a short TTI to a user terminal pertaining to the long TTI (see FIG. 2B). The indication information regarding preemption may be referred to as “preemption indication,” “preemption indication information,” “puncturing indication information,” “punctured resource information,” “impacted resource information,” and/or the like.

In this case, the user terminal can learn, from the preemption indication reported from the radio base station, that part of the data of the long TTI has been punctured. Which part is punctured is reported to the user terminal, so that the user terminal can select only the data addressed to the user terminal, and store it in the UE buffer. For example, the user terminal controls the storage in the soft buffer by replacing the log likelihood ratio (LLR) of the data part corresponding to the punctured part with 0.

Also, in the event preemption is employed, the part in a long TTI where a short TTI is scheduled may be retransmitted on a selective basis. In this case, the problem is how to control the retransmission. The present inventors have focused on the fact that which retransmission control method is suitable for use might vary depending on whether or not retransmission control is implemented in smaller units than TBs (for example, in CBG units), and come up with the idea of controlling receiving processes and/or transmission processes for delivery acknowledgement signals based on whether or not communication control based on CBGs is reported (configured) and whether or not communication control based on preemption indication of data (for example, TBs and/or CBGs) is reported (configured).

To be more specific, the present inventors have come up with the idea of separately configuring CBG-based transmission and/or retransmission control functions (CBG-based communication control function) and preemption indication-based transmission/receipt control functions (preemption indication-based communication control functions) (first example). Also, the present inventors have come up with the idea of controlling transmission processes and/or receiving processes based on information contained in downlink control information (for example, CBG retransmission scheduling information, preemption indication information, etc.). To be more specific, the present inventors have arrived at a communication control method for use when either CBG-based communication control functions or preemption indication-based communication control functions are configured, and when both of these are configured (second example to fourth example).

Now, embodiments of the present invention will be described below in detail with reference to the accompanying drawings. Note that, although the following description will show cases in which transmission and/or retransmission are controlled on a per CBG basis, the units that apply are by no means limited to CBGs, and any units that are smaller than TBs can be used. Note that, although the following description will presume asynchronous retransmission control (asynchronous HARQ), the herein-contained embodiments can be suitably applied to synchronous retransmission control (synchronous HARQ) as well. In synchronous HARQ, retransmission of each HARQ process takes place after a certain period from the initial transmission. On the other hand, in asynchronous HARQ, retransmission of each HARQ process takes place after an unspecified period from the initial transmission of this UL data.

Also, although the herein-contained embodiments will assume the use of a DL data channel (for example, Physical Downlink Shared CHannel (PDSCH)) as a DL signal, this is by no means limiting. For example, the retransmission control according to the herein-contained embodiments can also be applied to retransmission control of random access response (RAR) and/or the like. Also, the herein-contained embodiments can also be applied to UL signals such as UL data channels (for example, Physical Uplink Shared CHannel (PUSCH)).

Also, according to the herein-contained embodiments, a “preemption indication” may be transmitted using a physical channel for preemption indications, included in common DCI, included in UE-specific DCI (for example, DCI to schedule retransmitting data) or included in a Medium Access Control (MAC) control element. In addition, a “timing” as used in the herein-contained embodiments may be a given point in time, or may be a time period having a certain width (for example, a TTI, a Symbol, etc.).

### FIRST EXAMPLE

A network (for example, a radio base station) configures CBG-based communication control functions and preemption indication-based communication control functions in a user terminal, separately. The radio base station configures one or both of CBG-based communication control functions and preemption indication-based communication control functions depending on the user terminal's capabilities and/or the communicating environment. Note that it is not necessary to configure both communication control functions based on CBGs and communication control functions based on preemption indications.

The radio base station may configure CBG-based communication control functions and preemption indication-based communication control functions in the user terminal by using higher layer signaling (for example, RRC signaling, broadcast signal, etc.) and/or downlink control information (DCI).

The user terminal may report (transmit) capability (UE capability) information to indicate whether or not the user terminal can support transmission/retransmission based on CBGs and/or capability information to indicate whether or not the user terminal can support communication based on preemption indications, to the radio base station.

When only one type of communication control functions—for example, CBG-based communication control functions—are configured, the user terminal can control transmission processes (for example, HARQ-ACK feedback) and/or receiving processes (for example, receipt of retransmission data, storage in soft buffer, etc.) on a per CBG basis. Furthermore, when only one type of communication control functions—for example, preemption indication-based communication control functions—are configured, the user terminal controls transmission processes (for example, HARQ-ACK feedback) and/or receiving processes (for example, receipt of retransmission data, storage in soft buffer, etc.) based on preemption indication information. Also, when both CBG-based communication control functions and preemption indication-based communication control functions are configured, the user terminal controls transmission processes and/or receiving processes, in CBG units, based on preemption indication information (or puncturing indication information).

### SECOND EXAMPLE

According to a second example of the present invention, what transmission processes and receiving processes take place in a user terminal when only one type of communication control functions—namely, CBG-based communication control functions (transmission/retransmission based on CBGs)—are configured will be described.

A user terminal in which CBG-based transmission/retransmission is configured for DL controls the generation and feedback of A/Ns on a per CBG basis. Also, the user terminal receives downlink control information (DCI) that schedules data retransmission in units of CBGs (this is also referred to as “CBG granularity”). The downlink control information may be configured to include information that shows predetermined CBGs to be retransmitted (showing which CBGs are retransmitted).

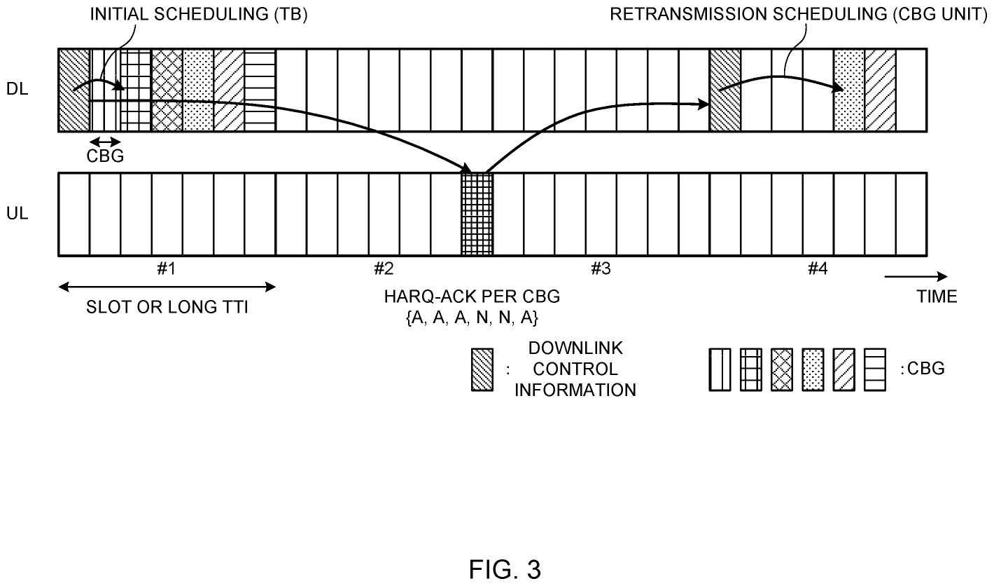

FIG. 3 shows an example of CBG-based A/N transmission and retransmission control. A case is illustrated here, in which there are four time periods (for example, slots or long TTIs), and in which a radio base station transmits data (TB) in first time period #1 (this time period will be hereinafter referred to as a “slot”). Data is scheduled by DCI. The DCI may include information about the CBGs that are scheduled (the number of CBGs, indices, whether transmission is carried out per TBs or per CBG, etc.).

The user terminal generates A/Ns in response to received data (TB), per CBG, and sends feedback at a predetermined later timing (here, in slot #2). Also, a case is shown here in which the user terminal allocates A/Ns corresponding to respective CBGs, to the same channel (PUCCH and/or PUSCH) or the same resource, and transmits them.

In the case shown in FIG. 3, downlink control information to schedule the data of slot #1 indicates the timing for sending A/N feedback, but the timing for A/N feedback is by no means limited to this.

The radio base station controls retransmission on a per CBG basis, based on A/Ns reported from the user terminal. Here, while a number of CBGs are included in a TB, some CBGs, for which NACK has been reported from the user terminal, are retransmitted in a selective manner.

For example, the radio base station reports, to the user terminal, which CBGs will be scheduled for retransmission, by using downlink control information. In this case, retransmitting CBGs' indices and/or the like may be included in the downlink control information.

Also, the radio base station may report information about the resources where the retransmitting CBGs are scheduled (allocated), to the user terminal, by using downlink control information. In this case, information about the resources (for example, at least one of PRBs, symbols, layers and timings) to which retransmitting CBGs are allocated may be included in downlink control information.

Also, the radio base station may report information as to how CBG retransmission is controlled, to the user terminal, by using downlink control information. In this case, the modulation/coding scheme (MCSs) and/or the coding rate used to retransmit CBGs may be included in downlink control information.

The user terminal controls receiving processes based on downlink control information that schedules CBG retransmissions. As shown in FIG. 3, retransmission is controlled on a per CBG basis, so that it is not necessary to retransmit the data that corresponds to CBGs that have been successfully received at the user terminal's end, and the overhead of retransmitting data can be reduced.

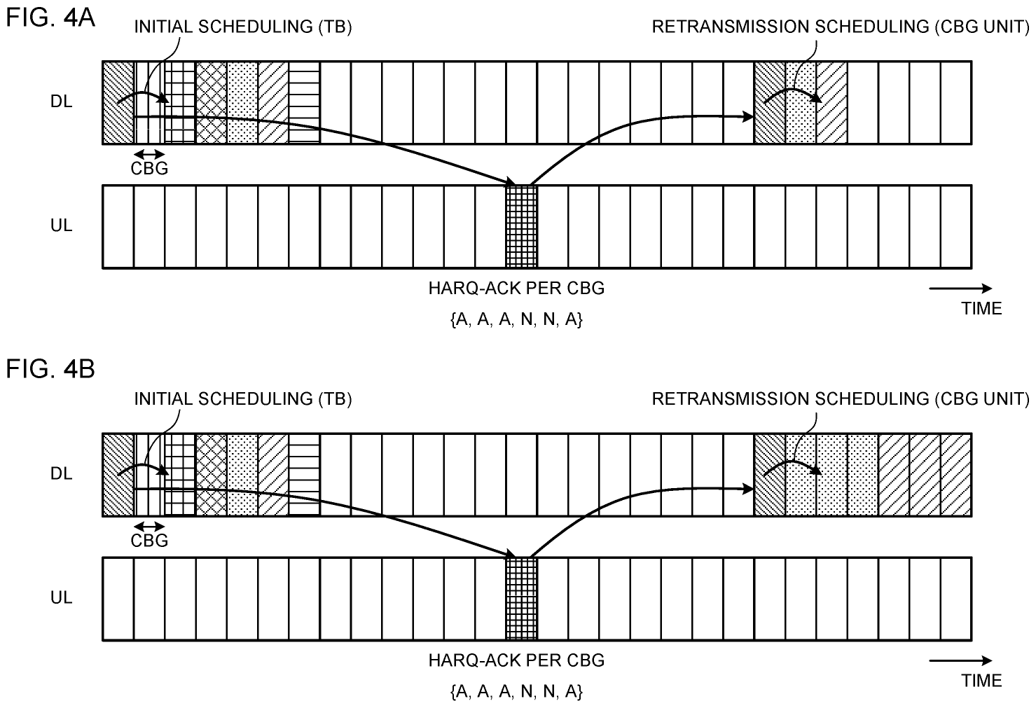

FIG. 3 shows a case in which, when retransmission takes place in units of CBGs (in slot #4), the retransmitting CBGs are allocated to the same radio resources (for example, time and/or frequency resources) as in transmission before the retransmission (for example, the initial transmission in slot #1), but the method of retransmission is by no means limited to this. For example, the locations of retransmitting CBGs in the time direction (for example, the symbol numbers or the locations where the retransmitting CBGs in this slot are mapped) may be changed (see FIG. 4A).

FIG. 4A shows a case in which, where a number of CBGs are included in a TB, retransmission is controlled by shifting some of the CBGs where NACK is detected along the time direction. For example, the radio base station removes a CBG for which ACK is reported, and shifts and retransmits the predetermined CBG in the time direction so that this predetermined CBG can be retransmitted at an earlier timing. In this way, predetermined CBGs can be retransmitted at earlier timings.

Alternatively, a predetermined retransmitting CBG may be transmitted over multiple time resources (for example, symbols). For example, in a TB in which CBGs for which ACK has been reported are removed, the radio base station may control retransmission by keeping retransmitting predetermined CBGs in the time direction (see FIG. 4B). FIG. 4B shows a case in which, among the 6 CBGs included in a TB, 2 CBGs where NACK is detected are retransmitted by using multiple time resources of the TB (here, using 3 symbols each). As described above, by expanding the range of time resources to use to transmit predetermined retransmitting CBGs, the coding rate for retransmitting data can be lowered, so that the rate of successful receipt at user terminals can be improved.

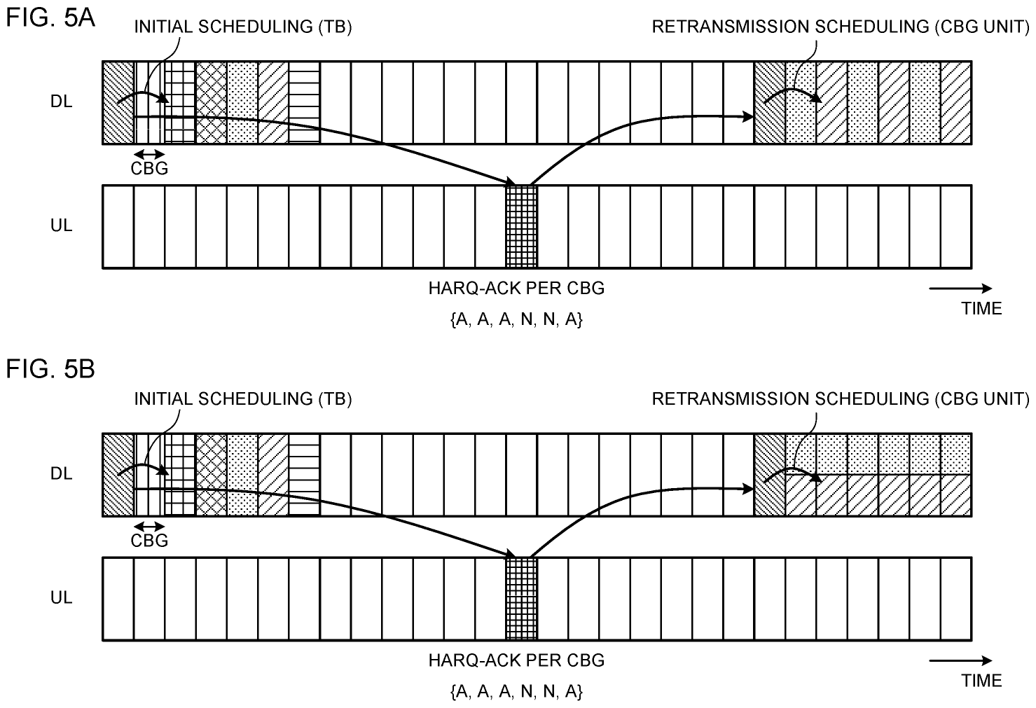

FIG. 4B shows a case in which, when a predetermined CBG is retransmitted using a number of time resources, the predetermined CBG is mapped to contiguous time resources, but this is by no means limiting. For example, when there are a number of predetermined CBGs to retransmit, each CBG may be mapped in order, in units of time resources (for example, symbols) (see FIG. 5A). By this means, each CBG's transmission timing can be configured earlier (the timing for each CBG's receiving processes in the user terminal can be made earlier), and, furthermore, the coding rate for retransmitting data can be configured low.

Alternatively, frequency resources for retransmitting CBGs may be changed (see FIG. 5B). FIG. 5B shows a case in which, when multiple CBGs are retransmitted, these CBGs are frequency-multiplexed with each other and transmitted using multiple time resources. Note that the locations of multiple CBGs in frequency may be switched for each time resource.

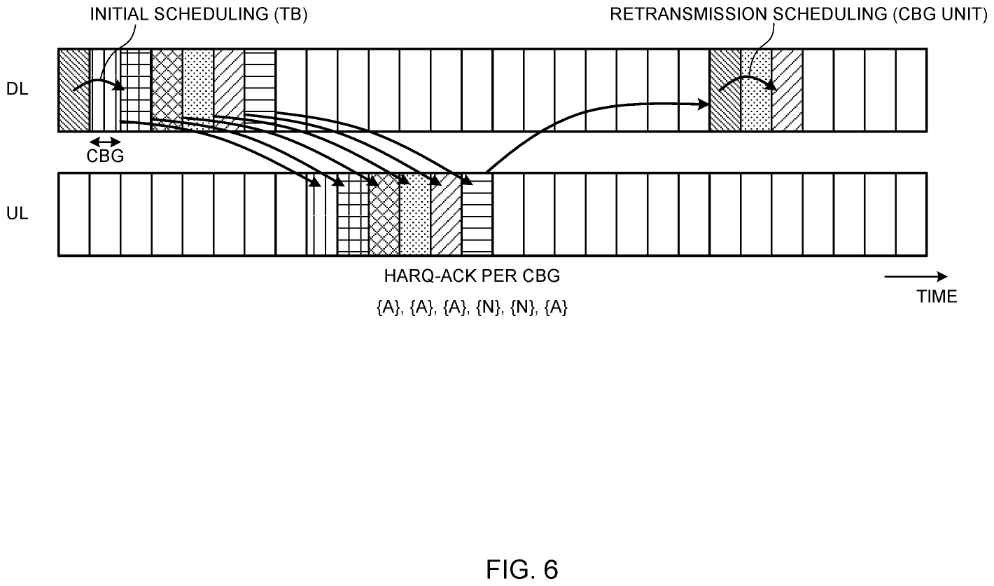

Also, FIG. 3 to FIGS. 5 have shown cases in which A/Ns in response to each CBG are transmitted together in the same channel (or in the same resource) as feedback, but this is by no means limiting. For example, A/Ns in response to each CBG may be transmitted as feedback using different channels (or different resources) (see FIG. 6). FIG. 6 shows a case in which A/Ns in response to each CBG are transmitted as feedback by using UL channels (for example, PUCCHs and/or PUSCHs) that are respectively transmitted in different time resources, In this case, the radio base station can process A/Ns in response to each CBG sequentially, instead of processing A/Ns in response to all CBGs collectively, so that the processing speed can be improved.

Note that A/N feedback in response to each CBG may be configured to be sent a predetermined period (for example, 1 slot) after each CBG is received, or may be configured to be transmitted at a timing specified by downlink control information that schedules each CBG (data). The radio base station controls retransmission based on A/Ns corresponding to each CBG, reported using different channels and/or resources. For this retransmission control, any one of the methods shown in FIG. 3 to FIGS. 5 may be used.

As shown in FIG. 6, A/Ns in response to multiple CBGs contained in the same TB are transmitted in different time resources, as feedback, so that it is possible to send feedback of A/Ns for CBGs that are transmitted at earlier timings among the multiple CBGs. By this means, a user terminal can start generating A/Ns to send as feedback, without receiving all the CBGs included in the same TB, so that the user terminal's burden related to A/N generation processes can be reduced.

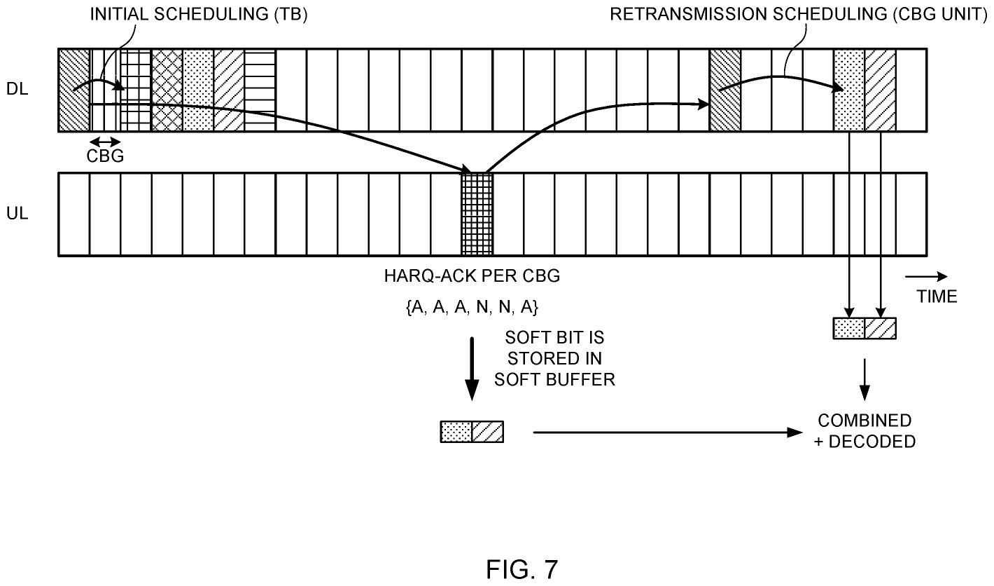

Also, the user terminal stores data (soft bits) the UE buffer (soft buffer) depending on results of receiving data (A/N). In this case, the user terminal controls storage in the soft buffer per TB and/or per CBG. FIG. 7 shows an example of storing soft bits in a soft buffer on a per CBG basis.

The user terminal performs receiving processes for data (for example, a TB that is comprised of multiple CBGs) transmitted from the radio base station, and detects A/Ns per CBG. Then, the user terminal stores soft bits that correspond to predetermined CBGs for which NACK is detected, in the soft buffer, per CBG. FIG. 7 shows a case in which NACK is detected in respect to 2 CBGs among multiple CBGs included in a TB, and these predetermined CBGs where NACK is detected are stored in a soft buffer. The user terminal receives CBGs retransmitted from the radio base station, combines them with soft bits stored in the soft buffer, and performs the decoding process. CBGs that fail to be decoded are stored in the soft buffer on a per CBG basis.

In this way, storage in the soft buffer is controlled on a per CBG basis, so that it is no longer necessary to store successfully-received CBGs, and, as a consequence, the volume to be stored in the soft buffer can be reduced. In particular, when the capacity of the user terminal's soft buffer is small, storing in units of CBGs would be effective.

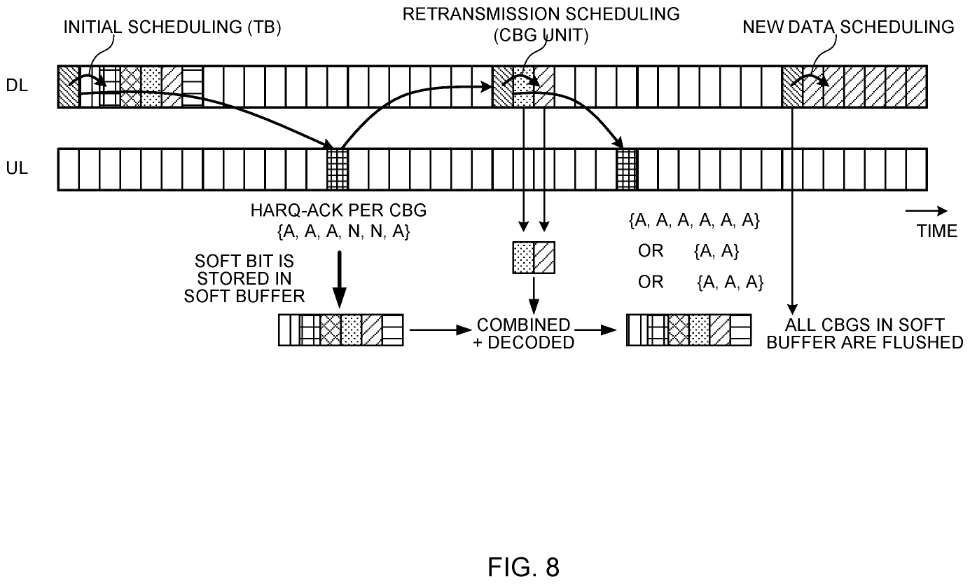

Also, the user terminal may store CBGs in a soft buffer per TB (or for all CBGs) and combine them with retransmitting data that is transmitted per CBG, to control receiving processes (see FIG. 8). In FIG. 8, the user terminal performs receiving processes for the data (for example, a TB that is comprised of multiple CBGs) transmitted from the radio base station, and detects A/Ns per CBG. Then, if there is at least one predetermined CBG that yields NACK, the user terminal stores soft bits corresponding to each CBG in the soft buffer. In this case, soft bits that correspond to CBGs where ACK is detected are also stored in the soft buffer. That is, CBGs are stored in the soft buffer on a per TB basis. In this way, by storing CBGs in a soft buffer in units of TBs, even when retransmission control is implemented in units of CBGs and then subsequent retransmission control is implemented by switching to TB units, soft bits that are stored in soft buffer can be used to improve the performance of error correction.

The user terminal receives retransmitted CBGs, and then combines them with soft bits stored in the soft buffer, and performs the decoding process. The user terminal transmits A/Ns as feedback based on the result of the decoding process. As to which A/Ns are subject to feedback from the user terminal, A/Ns in response to all the CBGs included in a TB, A/Ns in response to retransmitted CBGs, or combinations of A/Ns in response to TBs and A/Ns in response to retransmitted CBGs may be subject to feedback from the user terminal.

For example, if all the predetermined CBGs that are retransmitted are decoded successfully, the user terminal sends {A, A, A, A, A, A} which shows A/Ns in response to all the CBGs contained in a TB, as feedback. Alternatively, the user terminal transmits {A, A} which shows A/Ns in response to retransmitted CBGs, as feedback. Alternatively, the user terminal transmits {A, A, A}, as feedback, showing a combination of A/Ns in response to the TB and A/Ns in response to retransmitted. CBGs.

By reporting the combination of A/Ns in response to a TB and A/Ns in response to retransmitted CBGs, failures of A/N detection (for example, NACK-to-ACK errors) in the radio base station can be reduced.

Also, when the HARQ process stays the same and a new data indication is received, the user terminal may flush (delete) the soft bit for that HARQ process in the soft buffer. By this means, the user terminal's soft buffer can be used effectively.

### THIRD EXAMPLE

With a third example of the present invention, what transmission processes and receiving processes take place in a user terminal when only one type of communication control functions—namely, communication control functions based on preemption indications (or preemption notice)—is configured will be described.

A user terminal where preemption notice is configured controls receiving processes, including storage in a soft buffer, based on preemption indication information (or puncturing indication information). The preemption indication information may be included in downlink control information and reported to the user terminal. The downlink control information may include downlink control information for scheduling retransmission of DL data, non-scheduling downlink control information, and so forth.

For example, the radio base station reports information about a part of the data that is punctured (information to show which part of data is punctured), to the user terminal, by using downlink control information. In this case, at least one of the symbol index, the PRB index, the CB index and the CBG index of the punctured part may be included in the downlink control information.

Also, the radio base station reports information about the method for processing the corresponding soft bits (LLR) (information to show how to process the punctured soft bits) to the user terminal by using downlink control information. In this case, information to command discarding the soft bits and/or information to command flushing the soft bits may be included in the downlink control information.

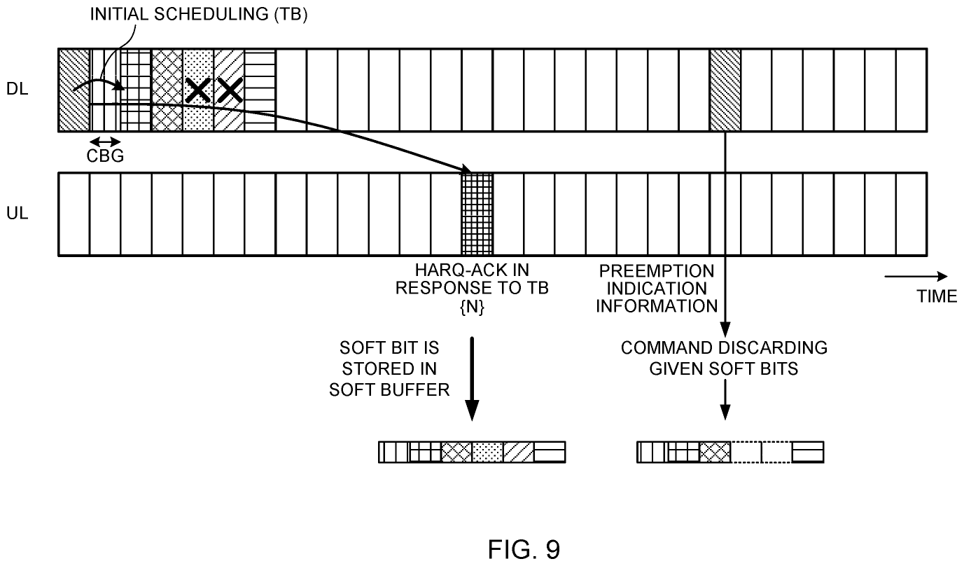

FIG. 9 shows an example of performing receiving processes (including, for example, storage of soft bits) based on preemption indication information.

The user terminal performs receiving processes for data transmitted from the radio base station (for example, a TB comprised of a number of CBGs). Here, CBG-based transmission/retransmission is not configured, so that the user terminal detects A/Ns in units of TBs and send them back as feedback. In addition, a case is assumed here in which, since part of the CBGs included in a TB are punctured, the user terminal cannot receive the TB properly and ends up detecting a NACK. The user terminal stores the soft bits that correspond to the TB (here, multiple CBGs) where the user terminal detected a NACK, in the soft buffer.

The radio base station learns that part or all of the CBGs in the long TTI are punctured based on preemption of the TB and/or the CBGs. Therefore, the radio base station reports information about the punctured part of data, as preemption indication information, to the user terminal.

The user terminal can obtain information about the puncturing of received data by receiving preemption indication information included in downlink control information. To be more specific, the user terminal discards part or all of the soft bits (corresponding to the punctured part), stored in the soft buffer, based on preemption indication information. Following this, the user terminal combines the data (for example, the TB) received by way retransmission, with soft bits stored in the soft buffer, and performs the decoding process.

In this way, soft bits that are stored in a soft buffer and that correspond to a given part (for example, a punctured part) are discarded (for example, replaced with 0) based on preemption indication information. By this means, it is possible to execute processes without taking unnecessary data into account when, for example, a retransmission is received and the demodulation process has to be performed, so that the decline in the performance of the demodulation process and/or demodulation errors can be reduced.

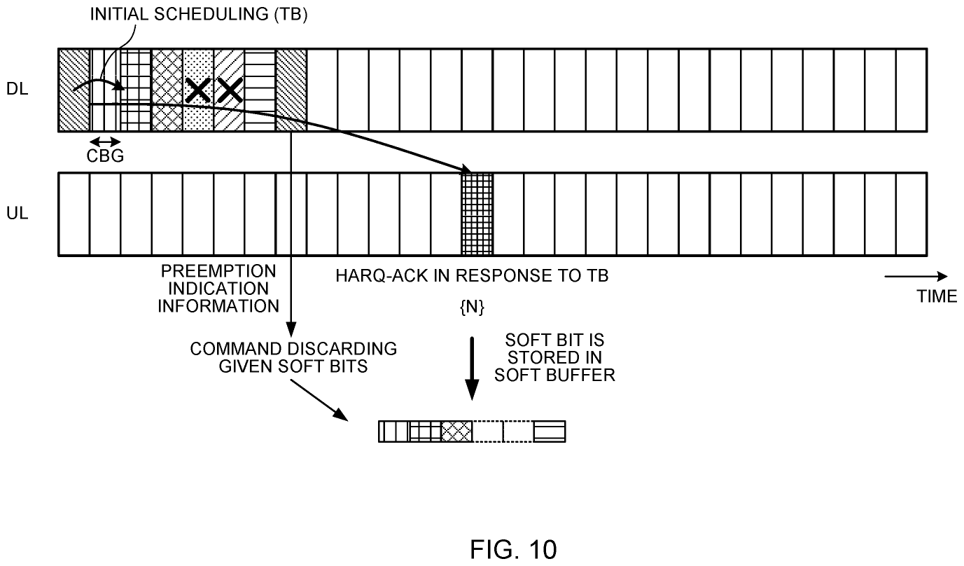

FIG. 9 shows a case in which preemption indication information is transmitted from a user terminal at a timing after A/N feedback is sent, but the timing for transmitting preemption indication information is not limited to this. Preemption indication information may be configured so as to be reported to the user terminal at a timing before the user terminal sends A/N feedback (see FIG. 10).

FIG. 10 shows a case in which, the user terminal receives preemption indication information before sending an A/N, as feedback, in response to that TB. In this case, the user terminal controls the storage into the soft buffer based on the result of the data receiving process (NACK in this case) and the preemption indication information.

For example, if the preemption indication information includes information that relates to the punctured part of the data (for example, a report for discarding a given CBG), the user terminal controls the soft bits corresponding the punctured part not to be stored (for example, to be replaced with 0). Following this, the user terminal combines data (TB) that is retransmitted and data that is stored in the soft buffer, and performs the decoding process.

As described above, preemption indication information is configured to be reported to a user terminal before A/N feedback is sent, so that, even when partially-punctured data is received, it is still possible to prevent unnecessary data from being stored in the soft buffer.

### FOURTH EXAMPLE

With a fourth example of the present invention, what transmission processes and receiving processes take place in terminal when both CBG-based communication control functions and preemption indication-based communication control functions are configured will be described. In this case, CBG is used as the common unit for retransmission and/or reporting preemption.

In a period in which preemption is not employed (for example, a period in which there are no interrupting short TTIs), a radio base station reports CBG retransmission to a user terminal by using downlink control information not including preemption indication (or puncturing indication) information. In this case, the bit field for preemption indication information in the downlink control information may be maintained and not be used (made 0), or downlink control information without a bit field for preemption indication information may be used.

For example, the radio base station reports, to the user terminal, which CBGs will be scheduled for retransmission, by using downlink control information. Also, the radio base station may report information about the resources where the retransmitting CBGs are scheduled (allocated), to the user terminal, by using downlink control information. Also, the radio base station may report information as to how CBG retransmission is controlled, to the user terminal, by using downlink control information.

When transmitting a preemption indication by using downlink control information, the radio base station may provide the preemption indication by using downlink control information that does not command scheduling of retransmission data. For example, the radio base station reports information about a part of data that is punctured (information to show which part of data is punctured), to the user terminal, by using downlink control information. Also, the radio base station reports information about the method for processing the corresponding soft bits (LLR) (information to show how to process the punctured soft bits) to the user terminal by using downlink control information.

Alternatively, when transmitting a preemption indication by using downlink control information, the radio base station may provide the preemption indication by using downlink control information that does not command scheduling of retransmission data. In this case, the radio base station may report, to the user terminal, information about puncturing of data that has already been transmitted (previous transmission) and information about the retransmission of the punctured part (for example, a given CBG) in downlink control information. For example, the radio base station reports, to the user terminal, the puncturing indication information for a given CBG, and retransmission scheduling information for the given CBG, by using downlink control information.

That is, information about a given CBG that is punctured and information about retransmission of the given CBG are reported to the user terminal, at the same time, by using downlink control information. Note that, information to indicate a given CBG that is punctured and information to indicate a CBG to be retransmitted may be included in separate bit fields and reported respectively, or may be included in a common bit field and reported.

The downlink control information may be configured to include a CBG granularity bit field that can identify CBGs that are punctured, and a CBG granularity bit field that can identify which CBGs are retransmitted. Note that, in the event the information to indicate the given punctured CBGs and the information to indicate retransmitting CBGs are common, the number of bit fields for reporting given CBGs may be made one.

When the puncturing indication information for reporting information about puncturing of given CBGs and retransmission scheduling information for reporting retransmission of given CBGs are included in the same downlink control information, the user terminal discards (or flushes) the CBGs in the soft buffer and performs receiving process for retransmitted CBGs, based on that downlink control information.

To be more specific, the user terminal discards the given CBGs designated by the puncturing indication information, from the soft buffer, and, furthermore, performs the decoding process by combining the soft buffer without the given CBGs discarded, and retransmission data. By this means, undesirable data (punctured part) stored in the soft buffer can be removed, and then the given CBGs that are retransmitted can be combined and the decoding process can be performed. Note that, when the decoding results of retransmitted data yields errors (NACKs), only those soft bits that correspond to NACKs may be stored in the soft buffer.

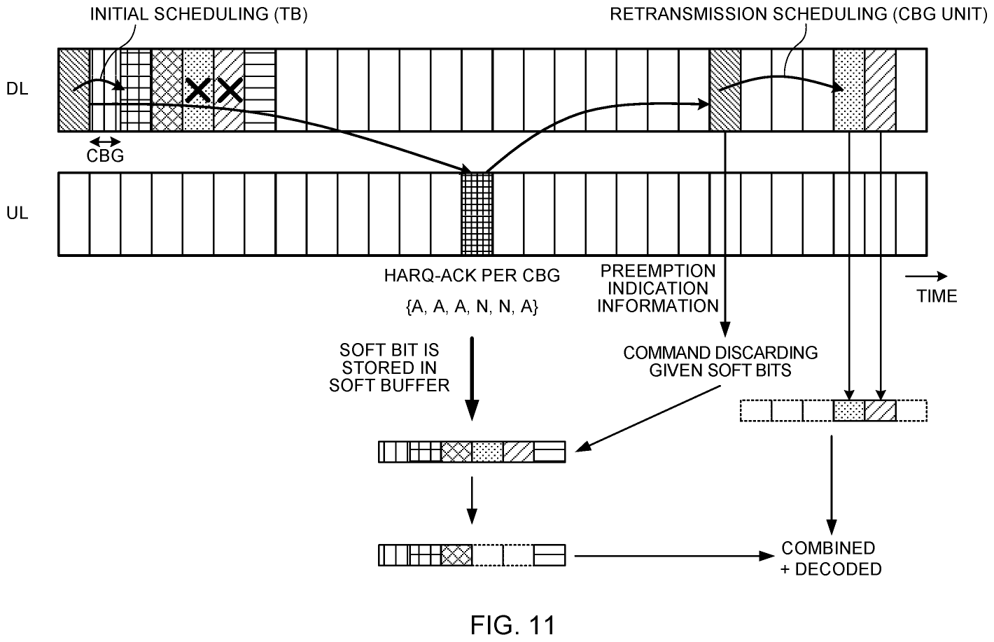

FIG. 11 shows an example where the user terminal performs receiving processes and so on based on downlink control information that includes preemption indication information and retransmission scheduling information.

The user terminal performs receiving processes for data (for example, a TB that is comprised of multiple CBGs) transmitted from the radio base station. Here, CBG-based transmission/retransmission is configured, so that the user terminal detects A/Ns in units of CBGs. In addition, a case is assumed here in which, since the part of the CBGs included in a TB are punctured, the user terminal detects NACK at least for these CBGs. The user terminal stores the soft bits that correspond to the CBGs where the user terminal detected NACK, in the soft buffer. In this case, as shown in FIG. 11, soft bits that correspond to CBGs where ACK is detected are also stored in the soft buffer. Obviously, CBGs for which NACK is detected may be stored on a selective basis.

The radio base station learns that part or all of the CBGs in the long TTI are punctured based on preemption that is used. Therefore, the radio base station reports information about the punctured part of data, as preemption indication information (or puncturing indication information), to the user terminal. The user terminal can obtain information about the puncturing of received data by receiving the preemption indication information included in downlink control information.

To be more specific, the user terminal discards part or all of the soft bits (corresponding to the punctured part), stored in the soft buffer, based on the preemption indication information. Also, the user terminal receives the retransmission data (given CBG) that is scheduled by the downlink control information including the preemption indication information. Then, the user terminal combines the given CBGs received, with soft bits stored in the soft buffer (in which the punctured part has been discarded), and performs the decoding process.

In FIG. 11, soft bits that are stored in the soft buffer and that correspond to the punctured part (given CBGs) can be discarded on a per CBG basis, based on preemption indication information, and then retransmitting data (for example, given CBG) that is transmitted in CBG units can be received and decoded. By this means, data that is not needed in the decoding process when a retransmission is received can be removed, and then the user terminal can perform the decoding process.

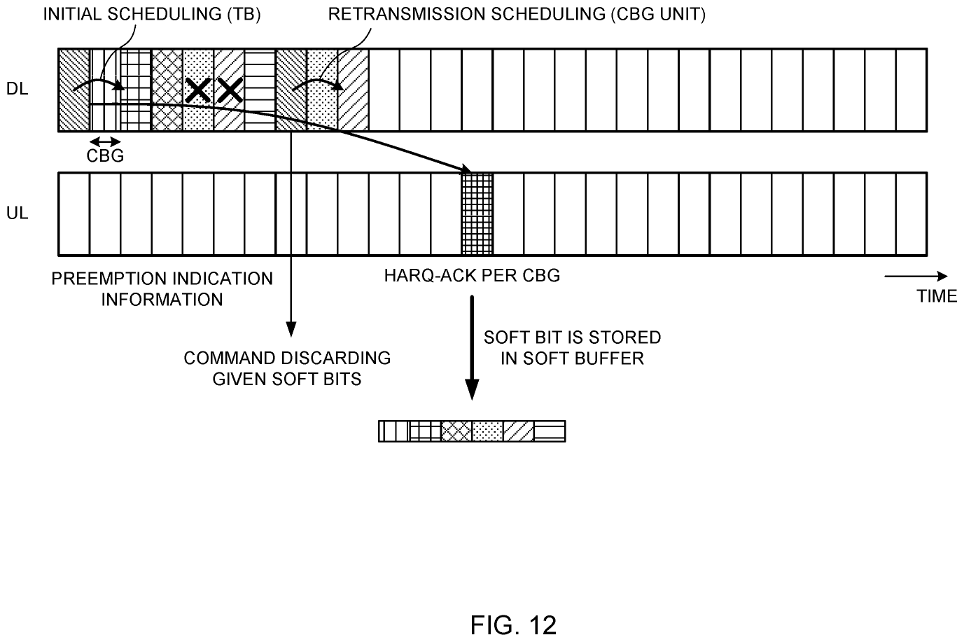

FIG. 11 shows a case in which preemption indication information is transmitted from a user terminal at a timing after A/N feedback is sent, but the timing for transmitting preemption indication information is not limited to this. Preemption indication information may be configured so as to be reported to the user terminal at a timing before the user terminal sends A/N feedback (see FIG. 12).

FIG. 12 shows a case in which, after the user terminal receives data (TB) that is partly punctured, the user terminal receives downlink control information which includes preemption indication information and scheduling information, before sending A/Ns per CBG included in that TB, as feedback. In this case, the user terminal can control the storage into the soft buffer based on the result of the data receiving process, and, in addition, based on the puncturing indication information and the result of retransmitted data receiving process.

For example, the user terminal may not store given CBGs indicated by puncturing indication information, amongst the initially-scheduled data, regardless of the result of decoding. On the other hand, the user terminal may store given CBGs received by way retransmission in the soft buffer. Note that, although a case is shown here in which soft bits are stored in the soft buffer even when ACK is detected, soft bits may be stored only when NACK is detected.

As described above, downlink control information to include preemption indication information and retransmission scheduling information is configured to be reported to a user terminal before A/N feedback is sent, so that, it is still possible to prevent unnecessary data from being stored in the soft buffer. To be more specific, even when given CBGs are punctured, given CBGs that are retransmitted can be stored without storing the part (given CBG) that was punctured upon the initial scheduling, in the soft buffer.

Note that FIG. 12 shows a case in which downlink control information for the initial scheduling of a TB indicates the timing for sending A/N feedback. In this case, as the timing for retransmitting a given CBG comes later, the time from receiving retransmission data to transmitting A/N as feedback will be shorter, the processing burden on the user terminal might increase.

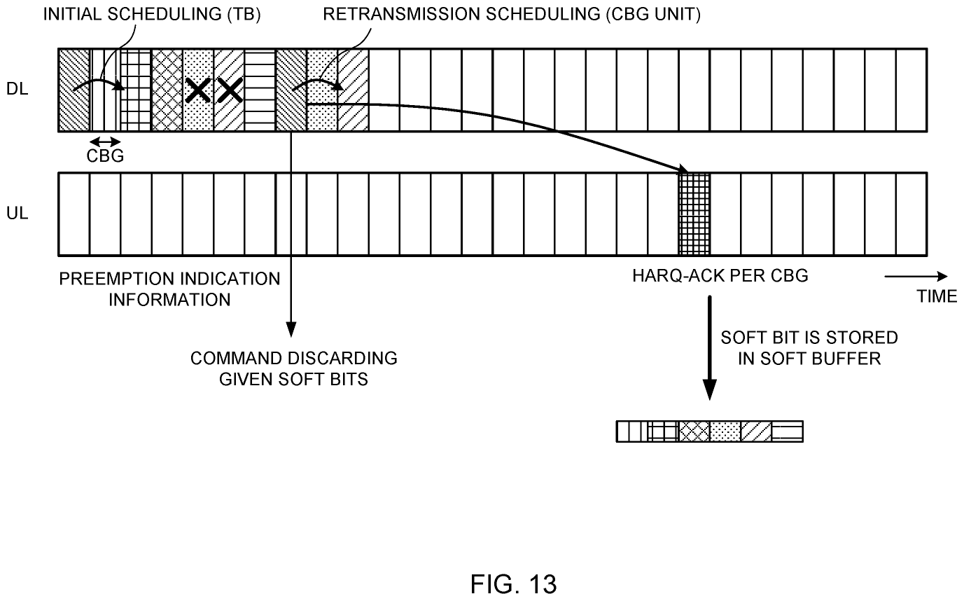

Consequently, the radio base station may specify the timing for transmitting A/N as feedback to the user terminal, by using downlink control information that schedules retransmitting data (downlink control information including preemption indication information) (see FIG. 13). By this means, even when scheduling of retransmitting data is delayed, a certain period of time can be provided after retransmitted data is received, until A/N feedback is transmitted. As a result of this, the burden of receiving processes in the user terminal can be reduced.

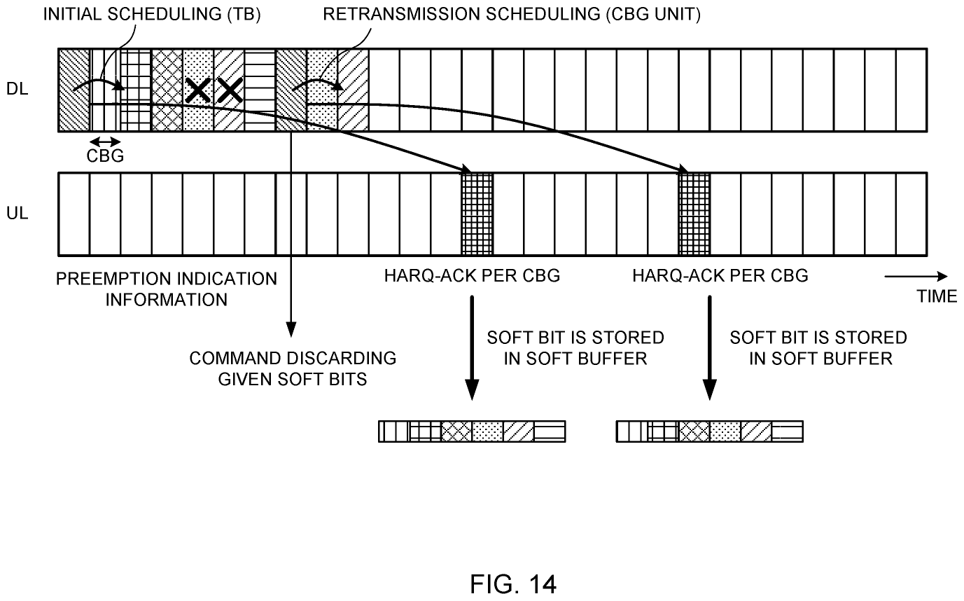

Alternatively, the timing of A/N feedback may be indicated by using downlink control information for the initial scheduling of TBs, and, furthermore, the timing for sending A/N feedback may be indicated using downlink control information that schedules retransmission of data (see FIG. 14). Note that A/Ns to be transmitted as feedback based on the indication of downlink control information for the initial scheduling and A/Ns to be transmitted as feedback based on the indication of downlink control information for scheduling retransmission of the data may represent the same contents, or represent different contents. Also, it is desirable that the user terminal transmits at least the A/Ns that are transmitted as feedback based on indication of downlink control information that schedules retransmission of data, but the user terminal may drop or stop the A/Ns that are transmitted as feedback based on indication of downlink control information for initial scheduling.

When A/Ns of the same content are transmitted as feedback at different timings, the A/N to show the receiving result upon receipt of the retransmission may be transmitted twice at different timings. In this case, the latest A/N result (the A/N result upon retransmission) can be reported at an early timing. On the other hand, when different contents of A/Ns are transmitted as feedback at different timings, the A/N to be transmitted at the first timing may be an A/N to show the receiving result of the initially-scheduled data, and the A/N to be transmitted later may be an A/N to show the receiving result of the retransmitted data. In this case, it is possible to reserve time after each data is received, until A/N feedback is sent, so that it is possible to reduce the burden of receiving processes on the user terminal.

(Radio Communication System)

Now, the structure of a radio communication system according to one embodiment of the present invention will be described below. In this radio communication system, communication is performed using one of the radio communication methods according to the herein-contained embodiments of the present invention, or a combination of these.

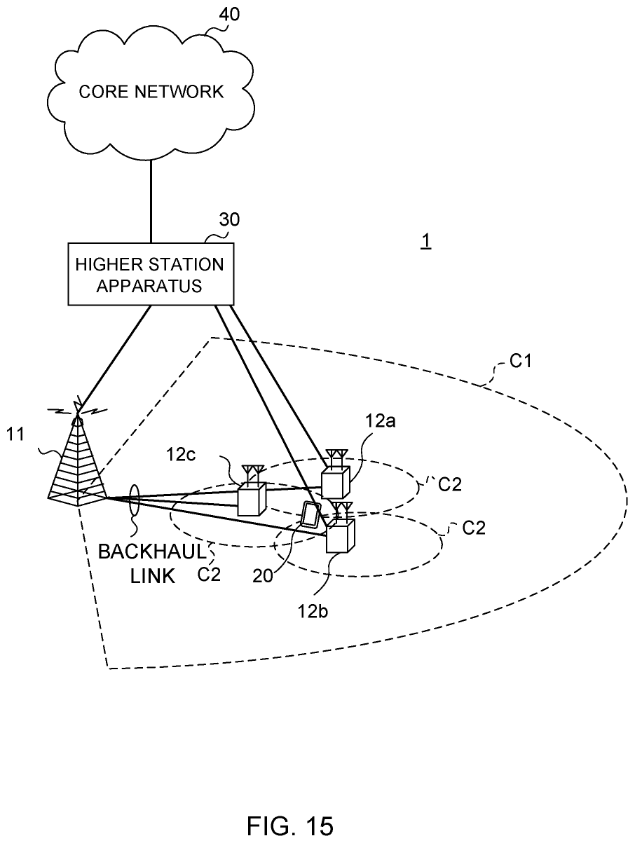

FIG. 15 is a diagram to show an exemplary schematic structure of a radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes 1 unit.

Note that the radio communication system 1 may be referred to as “Long Term Evolution (LTE),” “LTE-Advanced (LTE-A),” “LTE-Beyond (LTE-B),” “SUPER 3G,” “IMT-Advanced,” “4th generation mobile communication system (4G),” “5th generation mobile communication system (5G),” “New Radio (NR),” “Future Radio Access (FRA),” “New-RAT (Radio Access Technology),” and so on, or may be seen as a system to implement these.

The radio communication system 1 includes a radio base station 11 that forms a macro cell C1 having a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement and number of cells and user terminals 20 and so forth are not limited to those illustrated in the drawing.

The user terminals 20 can connect with both the radio base station 11 and the radio base stations 12. The user terminals 20 may use the macro cell C1 and the small cells C2 at the same time by means of CA or DC. Furthermore, the user terminals 20 may apply CA or DC using a plurality of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a plurality of different numerologies may be used.

The radio base station 11 and a radio base station 12 (or 2 radio base stations 12) may be connected with each other by cables (for example, by optical fiber, which is in compliance with the Common Public Radio Interface (CPRI), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNodeB (eNB)” a “transmitting/receiving point” and so on. Also, the radio base stations 12 are radio base stations having local coverages, and may be referred to as “small base stations,” “micro base stations,” “pico base stations,” “femto base stations,” “Home eNodeBs (HeNBs),” “Remote Radio Heads (RRHs),” “transmitting/receiving points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to these combinations, and other radio access schemes may be used as well.

In the radio communication system 1, a downlink shared channel (Physical Downlink Shared CHannel (PDSCH)), which is used by each user terminal 20 on a shared basis, a broadcast channel (Physical Broadcast CHannel (PBCH)), downlink L1/L2 control channels and so on are used as downlink channels. User data, higher layer control information. System Information Blocks (SIBS) and so on are communicated in the PDSCH. Also, the Master Information Blocks (MIBs) is communicated in the PBCH.

The downlink L1/L2 control channels include a Physical Downlink Control CHannel (PDCCH), an Enhanced Physical Downlink Control CHannel (EPDCCH), a Physical Control Format Indicator CHannel (PCFICH), a Physical Hybrid-ARQ Indicator CHannel (PHICH) and so on. Downlink control information (DCI), which includes PDSCH and/or PUSCH scheduling information, and so on are communicated by the PDCCH.

Note that scheduling information may be reported in DCI. For example, DCI to schedule receipt of DL data may be referred to as a “DL assignment,” and DCI to schedule data transmission may also be referred to as a “UL grant.”

The number of OFDM symbols to use for the PDCCH is communicated by the PCFICH. Hybrid Automatic Repeat reQuest (HARQ) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (Physical Uplink Shared CHannel (PUSCH)), which is used by each user terminal 20 on a shared basis, an uplink control channel (Physical Uplink Control CHannel (PUCCH)), a random access channel (Physical Random Access CHannel (PRACH)) and so on are used as uplink channels. User data, higher layer contra information and so on are communicated by the PUSCH. Also, in the PUCCH, downlink radio quality information (Channel Quality Indicator (CQI)), delivery acknowledgment information, scheduling requests (SRs) and so on are communicated. By means of the PRACH, random access preambles for establishing connections with cells are communicated.

In the radio communication system 1, cell-specific reference signals (CRSS), channel state information reference signals (CSI-RSs), demodulation reference signals (DMRSs), positioning reference signals (PRSs) and so on are communicated as downlink reference signals. Also, in the radio communication system 1, measurement reference signals (Sounding Reference Signals (SRSs)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

(Radio Base Station)

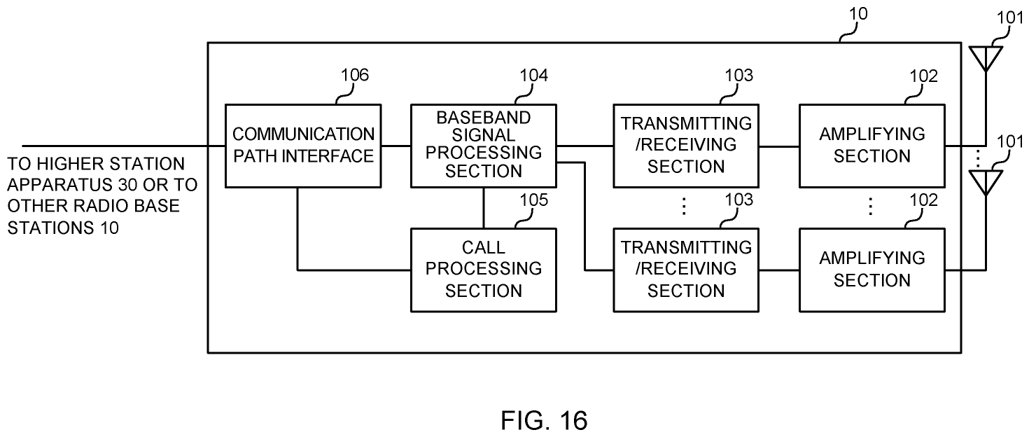

FIG. 16 is a diagram to show an exemplary overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a Packet Data Convergence Protocol (PDCP) layer process, user data division and coupling, Radio Link Control (RLC) layer transmission processes such as RLC retransmission control, Medium Access Control (MAC) retransmission control (for example, an Hybrid Automatic Repeat reQuest (HARQ) transmission process), scheduling, transport format selection, channel coding, an inverse fast Fourier transform (IFFT) process and a preceding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the Common Public Radio Interface (CPRD, the X2 interface, etc.).

The transmitting/receiving sections 103 transmit a transport block (TB) comprised of one or more code block groups (CBG) and receive a delivery acknowledgment signal in response to the TB and/or the CBGs. Also, the transmitting/receiving sections 103 transmit information as to whether or not communication control based on CBGs is reported and whether or not communication control based on preemption indication for the TB and/or the CBGs is reported. Also, the transmitting/receiving sections 103 transmit downlink control information including retransmission scheduling information and/or preemption indication information for predetermined CBGs.

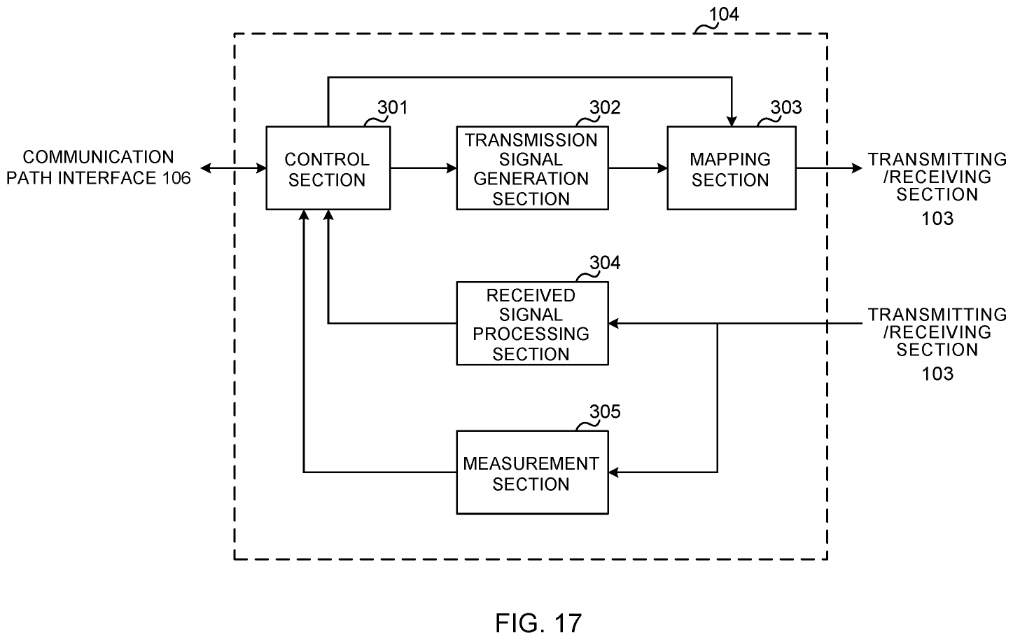

FIG. 17 is a diagram to show an exemplary functional structure of a radio base station according to the present embodiment. Note that, although this example primarily shows functional blocks that pertain to characteristic parts of the present embodiment, the radio base station 10 may have other functional blocks that are necessary for radio communication as well.

The baseband signal processing section 104 at least has a control section (scheduler) 301, a transmission signal generation section 302, a mapping section 303, a received signal processing section 304 and a measurement section 305, Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PUSCH) and downlink control signals (for example, signals transmitted in the PUCCH and/or the EPDCCH, such as delivery acknowledgment information). Also, the control section 301 controls the generation of downlink control signals, downlink data signals and so on, based on the results of deciding whether or not retransmission control is necessary in response to uplink data signals and so on. Also, the control section 301 controls the scheduling of synchronization signals (for example, Primary Synchronization Signal (PSS)/Secondary Synchronization Signal (SSS)), downlink reference signals (for example, CRSs, CSI-RSs, DMRSs and so on) and so on.

The control section 301 also controls the scheduling of uplink data signals (for example, signals transmitted in the PUSCH), uplink control signals (for example signals transmitted in the PUCCH and/or the PUSCH, such as delivery acknowledgment information), random access preambles (for example, signals transmitted in the PRACH), uplink reference signals, and so forth.

The control section 301 controls transmission and/or retransmission based on CBGs, and controls scheduling by applying preemption. For example, the control section 301 exerts control so that retransmission scheduling information for predetermined CBGs and preemption indication information are included in downlink control information and transmitted.

The transmission signal generation section 302 generates downlink signals (downlink control signals, downlink data signals, downlink reference signals and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates and modulation schemes that are selected based on, for example, channel state information (CSI) from each user terminal 20.

The mapping section 303 maps the downlink signals generated in the transmission signal generation section 302 to predetermined radio resources based on commands from the control section 301, and outputs these to the transmitting/receiving sections 103 The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). For the received signal processing section 304, a signal processor, a signal processing circuit or signal processing apparatus that can be described based on general understanding of the technical field to which the present invention pertains can be used.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

For example, the measurement section 305 may perform Radio Resource Management (RRM) measurements, Channel State Information (CSI) measurements and so on, based on the received signals. The measurement section 305 may measure the received power (for example, Reference Signal Received Power (RSRP)), the received quality (for example, Reference Signal Received Quality (RSRQ), Signal to Interference plus Noise Ratio (SINR), Signal to Noise Ratio (SNR), etc.) the signal strength (for example, Received Signal Strength Indicator (RSSI)), transmission path information (for example, CSI) and so on. The measurement results may be output to the control section 301.

(User Terminal)

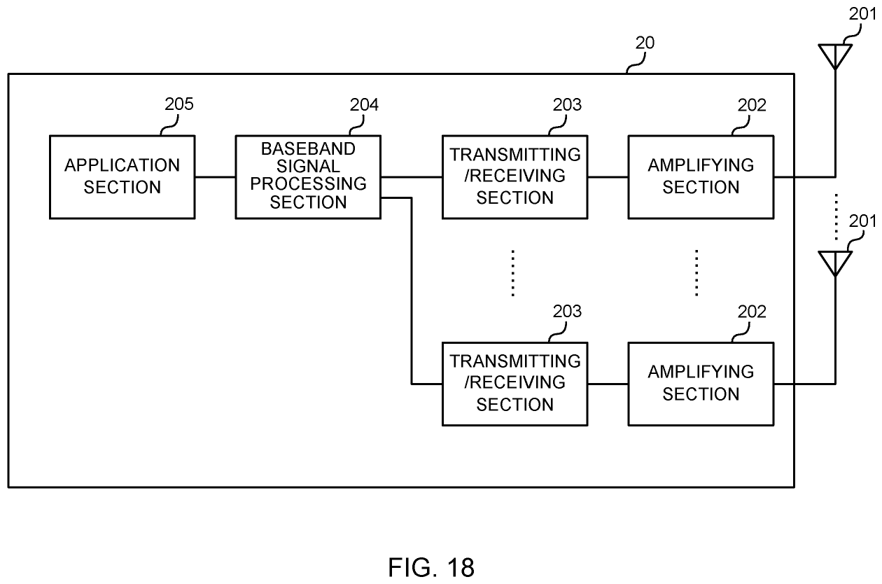

FIG. 18 is a diagram to show an exemplary overall structure of a user terminal according to one embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs receiving processes for the baseband signal that is input, including an EFT process, error correction decoding, a retransmission control receiving process and so on. Downlink user data is forwarded to the application section 205. The application section 205 performs processes related to higher layers above the physical layer and the MAC layer, and so on. In the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, preceding, a discrete Fourier transform (DFT) process, an IFFT process and so on, and the result is forwarded to the transmitting/receiving sections 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

The transmitting/receiving sections 203 receive a transport block (TB) comprised of one or more code block groups (CBG) and transmit a delivery acknowledgment signal in response to the TB and/or the CBGs. Also, the transmitting/receiving sections 203 receive information as to whether or not communication control based on CBGs is reported and whether or not communication control based on preemption indication for the TB and/or the CBGs is reported. Also, the transmitting/receiving sections 203 receive downlink control information including retransmission scheduling information and/or preemption indication information for predetermined CBGs.

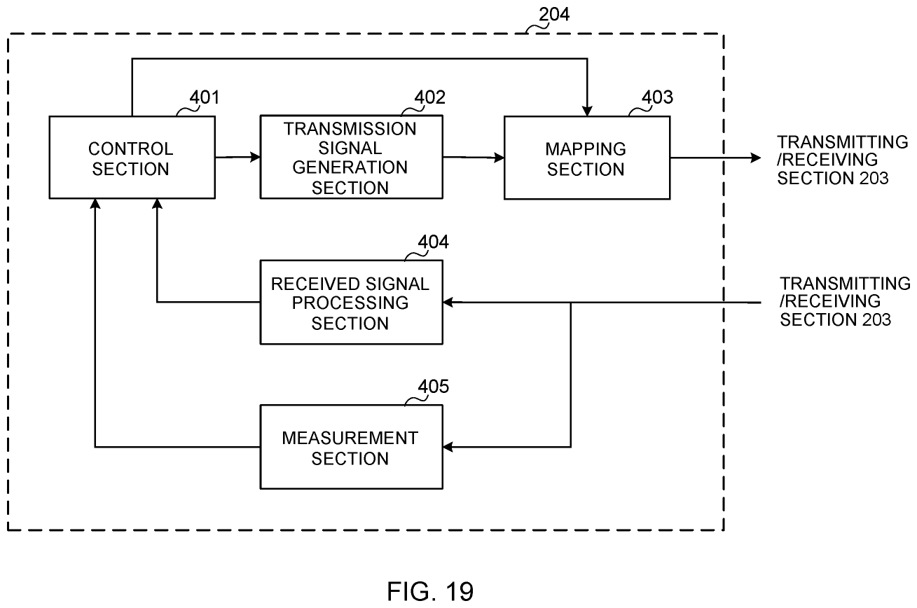

FIG. 19 is a diagram to show an exemplary functional structure of a user terminal according to the present embodiment. Note that, although this example primarily shows functional blocks that pertain to characteristic parts of the present embodiment, the user terminal 20 may have other functional blocks that are necessary for radio communication as

The baseband signal processing section 204 provided in the user terminal 20 at least has a control section 401, a transmission signal generation section 402, a mapping section 403, a received signal processing section 404 and a measurement section 405. Note that these configurations have only to be included in the user terminal 20, and some or all of these configurations may not be included in the baseband signal processing section 204.

The control section 401 controls the whole of the user terminal 20. For the control section 401, a controller, a control circuit or control apparatus that can be described based on general understanding of the technical to which the present invention pertains can be used.

The control section 401 controls, for example, generation of signals in the transmission signal generation section 402, allocation of signals in the mapping section 403, and so on. Furthermore, the control section 401 controls signal receiving processes in the received signal processing section404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on the results of deciding whether or not retransmission control is necessary for the downlink control signals and/or downlink data signals, and so on.

The control section 401 controls the transmission of delivery notification signals based on whether or not communication control based on CBGs is reported (configured), and whether or not communication control based on the TB and/or the CBGs is reported (configured). For example, the control section 401 controls transmission processes and/or receiving processes based on retransmission scheduling information for predetermined CBGs and/or preemption indication information, included in downlink control information.

When only CBG-based communication control is reported (or when downlink control information does not include preemption indication information and includes CBG retransmission scheduling information), the control section 401 transmits delivery acknowledgment signals per CBG, as feedback, by using different UL channels and/or resources. Also, when only preemption indication-based communication control is reported (or when downlink control information includes preemption indication information but does not include CBG retransmission scheduling information), the control section 401 transmits delivery acknowledgment signals per TB, as feedback (or per TB and/or per CB), and selects information to store in the soft buffer based on the preemption indication information.

When CBG based communication control and the preemption indication-based communication control are reported (or, downlink control information includes preemption indication information and CBG retransmission scheduling information), the control section 401 transmits delivery acknowledgment signals on a per CBG basis, as feedback, and selects information to store in the soft buffer, per CBG, based on the preemption indication information. In this case, the control section 401 exerts control so that before delivery acknowledgment signals are transmitted on a per CBG basis, retransmission of predetermined CBGs is received.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit or signal generation apparatus that can be described based on general understanding of the technical field to which the present invention pertains.

For example, the transmission information generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and output the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI) and so on. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire or wireless, for example) and using these multiple pieces of apparatus.

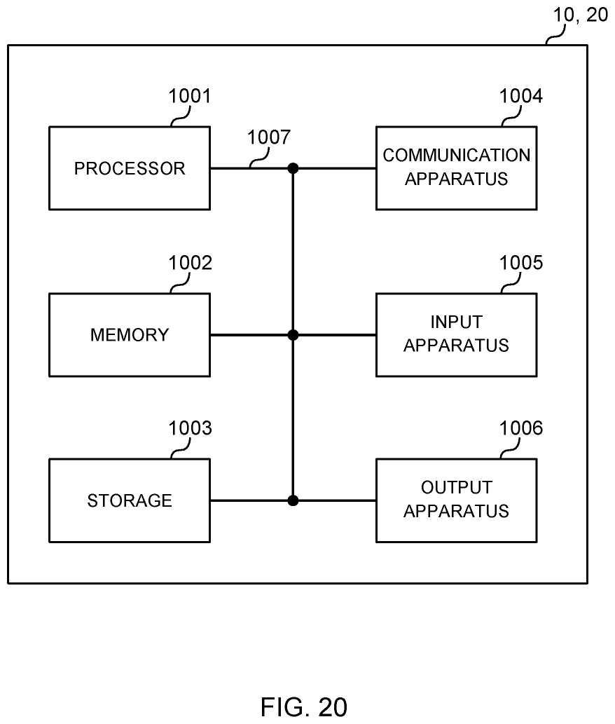

For example, the radio base station, user terminals and so on according to one embodiment of the present invention may function as a computer that executes the processes of the radio communication method of the present invention. FIG. 20 is a diagram to show an example hardware structure of a radio base station and a user terminal according to one embodiment of the present invention. Physically, the above-described radio base stations 10 and user terminals 20 may be formed as a computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be implemented with one processor, or processes may be implemented in sequence, or in different manners, on one or more processors. Note that the processor 1001 may be implemented with one or more chips.

The functions of the radio base station 10 and the user terminal 20 are implemented by allowing hardware such as the processor 1001 and the memory 1002 to read predetermined software (programs), thereby allowing the processor 1001 to do calculations, the communication apparatus 1004 to communicate, and the memory 1002 and the storage 1003 to read and/or write data.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a Read Only Memory (ROM), an Erasable Programmable ROM (EPROM), an Electrically EPROM (EEPROM), a Random Access Memory (RAM) and/or other appropriate storage media. The memory 1002 may be referred to as a “register,” a “cache,” a “main memory” (primary storage apparatus) and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a 131u-ray (registered trademark) disk), a removable disk, a hard disk drive, a smart card, a flash memory device (for example, a card, a stick, a key drive, etc), a magnetic stripe, a database, a server, and/or other appropriate storage media. The storage 1003 may be referred to as “secondary storage apparatus.”

The communication apparatus 1004 is hardware (transmitting/receiving apparatus) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an Light Emitting Diode (LED) lamp and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an Application-Specific Integrated Circuit (ASIC), a Programmable Logic Device (PLD), an Field Programmable Gate Array (FPGA) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals” (or “signaling”). Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or multiple slots in the time domain. A subframe may be a fixed time length (for example, 1 ms) not dependent on the numerology.

Furthermore, a slot may be comprised of one or more symbols in the time domain (Orthogonal Frequency Division Multiplexing (OFDM) symbols, Single-carrier Frequency Division Multiple Access (SC-FDMA) symbols, and so on). Also, a slot may be a time unit based on numerology. Also, a slot may include a plurality of mini-slots. Each mini-slot may be comprised of one or more symbols in the time domain. Also, a mini-slot may be referred to as a “subslot.”

A radio frame, a subframe, a slot, a mini-slot and a symbol all represent the time unit in signal communication. A radio frame, a subframe, a slot, a mini-slot and a symbol may be each called by other applicable names. For example, 1 subframe may be referred to as a “transmission time interval (TTI),” or a plurality of consecutive subframes may be referred to as a “TTI,” or 1 slot or mini-slot may be referred to as a “TTI.” That is, a subframe and/or a TTI may be a subframe (1 ms) in existing LTE, may be a shorter period than 1 ms (for example, 1 to 13 symbols), or may be a longer period of time than 1 ms. Note that the unit to represent the TT1 may be referred to as a “slot,” a “mini slot” and so on, instead of a “subframe.”

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. Note that the definition of TTIs is not limited to this.

The TTI may be the transmission time unit of channel-encoded data packets (transport blocks), code blocks and/or codewords, or may be the unit of processing in scheduling, link adaptation and so on. Note that, when a TTI is given, the period of time (for example, the number of symbols) in which transport blocks, code blocks and/or codewords are actually mapped may be shorter than the TTI.

Note that, when 1 slot or 1 mini-slot is referred to as a “TTI,” one or more TTIs (that is, one or multiple slots or one or more mini-slots) may be the minimum time unit of scheduling. Also, the number of slots (the number of mini-slots) to constitute this minimum time unit of scheduling may be controlled.

A TTI having a time length of 1 ms may be referred to as a “normal TTI (TTI in LTE Rel. 8 to 12),” a “long TTI,” a “normal subframe,” a “long subframe,” and so on. A TTI that is shorter than a normal may be referred to as a “shortened TTI,” a “short TTI,” “a partial TTI” (or a “fractional TTI”), a “shortened subframe,” a “short subframe,” a “mini-slot,” “a sub-slot” and so on.

Note that a long TTI (for example, a normal TTI, a subframe, etc.) may be replaced with a TTI having a time length exceeding 1 ms, and a short TTI example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be 1 slot, 1 mini-slot, 1 subframe or 1 TTI in length. 1 TTI and 1 subframe each may be comprised of one or more resource blocks. Note that one or more RBs may be referred to as a “physical resource block (Physical RB (PRB)),” a “subcarrier group (SCG),” a “resource element group (REG),” a “PRB pair,” an “RB pair” and so on.

Furthermore, a resource block may be comprised of one or more resource elements (REs). For example, 1 RE may be a radio resource field of 1 subcarrier and 1 symbol.

Note that the structures of radio frames, subframes, slots, mini-slots, symbols and so on described above are merely examples. For example, configurations pertaining to the number of subframes included in a radio frame, the number of slots included in a subframe, the number of mini-slots included in a slot, the number of symbols and RBs included in a slot or a mini-slot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to predetermined values, or may be represented using other applicable information. For example, a radio resource may be specified by a predetermined index.

The names used for parameters and so on in this specification are in no respect limiting. For example, since various channels (Physical Uplink Control CHannel (PUCCH), Physical Downlink Control CHannel (PDCCH) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a control table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI)), higher layer signaling (for example, Radio Resource Control (RRC) signaling, broadcast information (the master information block (MIB), system information blocks (SIBS) and so on), Medium Access Control (MAC) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, by reporting another piece of information, and so on).

Decisions may be made in values represented by 1 bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, Mobility Management Entities (MME), Serving-Gateways (S-GWs) and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to Long Term Evolution (LTE), LTE-Advanced (LTIE-A), LTE-Beyond (LTIE-B), SUPER 3G, IMT-Advanced, 4th generation mobile communication system (4G), 5th generation mobile communication system (5G), Future Radio Access (FRA), New-RAT (Radio Access Technology), New Radio (NR), New radio access (NX), Future generation radio access (FX), GSM (registered trademark) (Global System for Mobile communications), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication systems and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used herein only for convenience, as a method for distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.”

As used herein, when two elements are connected, these elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in the radio frequency, microwave and optical (both visible and invisible) regions.

In the present specification, the phrase “A and B are different” may mean “A and B are different from each other.” The terms such as “leave” “coupled” and the like may be interpreted as well.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A user terminal, comprising:
a receiving section that receives a transport block (TB) comprising one or more code block groups (CBGs);
a transmission section that transmits a delivery acknowledgment signal in response to the TB and/or the CBGs; and
a control section that controls a receiving process and/or a transmission process for the delivery acknowledgment signal based on whether or not communication control based on the CBGs is reported and whether or not communication control based on preemption indication for the TB and/or the CBGs is reported.

2. The user terminal according to claim 1, wherein, when the CBG-based communication control is reported, the control section transmits delivery acknowledgement signals per CBG, as feedback, by using different LT channels and/or resources.

3. The user terminal according to claim 1, wherein, when only the preemption indication-based communication control is reported, the control section transmits delivery acknowledgement signals per TB, as feedback, and selects information to store in a soft buffer based on the preemption indication.

4. The user terminal according to claim 1, wherein, when the CBG-based communication control and the preemption indication-based communication control are reported, the control section transmits delivery acknowledgement signals per CBG, as feedback, and selects information to store in a soft buffer, per CBG, based on the preemption indication.

5. The user terminal according to claim 1, wherein, when the CBG-based communication control and the preemption indication-based communication control are reported, the receiving section receives retransmission of a given CGB, before the delivery acknowledgement signals per CBG are transmitted.

6. A radio communication method for a user terminal, comprising the steps of:
receiving a transport block (TB) comprising one or more code block groups (CBGs);
transmitting a delivery acknowledgment signal in response to the TB and/or the CBGs; and
controlling a receiving process and/or a transmission process for the delivery acknowledgment signal based on whether or not communication control based on the CBGs is reported and whether or not communication control based on preemption indication for the TB and/or the CBGs is reported.

7. The user terminal according to claim 4, wherein, when the CBG-based communication control and the preemption indication-based communication control are reported, the receiving section receives retransmission of a given CGB, before the delivery acknowledgement signals per CBG are transmitted.
